(19) United States
(12) Patent Application Publication
(10) Pub. No.: US 2009/0080869 A1
(43) Pub. Date: Mar. 26, 2009

(54) BROADCAST PROGRAM DISPLAYING APPARATUS, BROADCAST PROGRAM DISPLAYING METHOD, AND BROADCAST PROGRAM DISPLAYING SYSTEM

(76) Inventors: Junji Yoshida, Osaka (JP); Masazumi Yamada, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/278,192

(22) PCT Filed: Feb. 21, 2007
(86) PCT No.: PCT/JP2007/053159

§ 371 Date: Aug. 4, 2008

(30) Foreign Application Priority Data
Feb. 24, 2006 (JP) 2006-048955

(51) Int. Cl. H04N 5/00; H04N 5/50; H04N 5/445

(52) U.S. Cl. 386/126; 348/731; 725/58; 348/E05.097

(57) ABSTRACT

A TV is provided for enabling a viewer to continuously watch a program which has been received even though a TV broadcast receiver is switched from a TV tuner to an apparatus for external input. A TV (131) transmits an output start instruction command to a DVD decoder (101) selected as the apparatus for external input (Step 201). Upon receiving the output start instruction command, the DVD recorder (101) transmits the output start notification command to the TV (131) (Step 202). Upon receiving the output start notification command, the TV (131) switches the input path to the DVD recorder (101) (Step 203), and transmits, to the DVD recorder (101), a channel selecting command including information showing a channel which the viewer has watched (Step 204). When receiving the selection command, the DVD recorder (101) changes the channel selection on the tuner (103) to the channel which the information showing the channel in the channel selecting command.

### TECHNICAL FIELD

The present invention relates to channel selection controlling techniques in receiving to reproduce a radio broadcast program or a cable broadcast program, and more particularly, to a channel selection controlling technique enabling the same program to be watched continuously regardless of a reception path both on a broadcast program displaying apparatus and a recording and reproducing apparatus which can receive to reproduce a radio broadcast program.

### BACKGROUND ART

A typical TV receiver (“TV”, hereinafter) is connected to a video device, such as a VCR (Video Cassette Recorder) and a DVD recorder to present a reproduced content on the devices, and shows a game content via a connected home-use game console, as well as receives TV broadcast for a viewer to watch. Thus, most TVs have one or more external input terminals in addition to an antenna terminal for receiving the TV broadcast. A user uses a remote control or a button on the TV to switch between the external input and the internal tuner of the TV in accordance with the user's purpose.

Moreover, in general, most video devices are equipped with a tuner, and are able to receive TV broadcast. A typical video device outputs received TV broadcast program to a displaying unit, such as a TV, when not reproducing an accumulated content therein. Hence, the TV broadcast program can be watched on the video device, switching to an external input of the TV.

Thus, an apparatus and a method are standardized for automatically switching an input path (from a built-in tuner to a video device connected to an external input terminal, for example), utilizing a command exchanged between the TV and the video device, the input path being of video audio data on TV.

For example, a command is defined for coordinating the TV and the video device to operate (See Non-patent Reference 1, for example). This allows: the external input on the TV to be automatically switched to the video device; and a content currently being reproduced on the video device to be displayed on the TV, by the video device issuing an output start notification command to the TV when, for example, the video device starts the reproduction.

In addition, upon transmitting the output start instruction command from the TV to the video device when the video device on which the user intends to watch is selected on TV, an output start notification command is issued to the TV. The exchange of the command as described above allows: the external input of the TV to be switched to the video device; and then the content currently being reproduced by the video device to be displayed on the TV.

Further, even in the case where a repeater and an input switching device (selector) are connected between the TV and the video device, the content currently being reproduced by the video device can be displayed on the TV due to a correct response of the repeater and the input switching device to the output start notification command.

### Non-Patent Reference 1: The HDMI (High-Definition Multimedia Interface) Specification Version 1.2.

### DISCLOSURE OF INVENTION

### Problems that Invention is to Solve

The above-mentioned conventional technique has problems as follows. Specifically, in the case where the external input on the TV is switched to the video device, for example, (the external input may be switched either manually with an ordinary TV remote or automatically as described in the Non-patent reference 1) a TV program channel set on the video device may not necessarily correspond with a TV program channel which the user has watched on the TV. This is very troublesome since the user who desires to watch the same program as the user has watched on the TV needs to change (or set) the channel on the video device to the channel on the TV after switching (or before switching) the external input.

The present invention is conceived in view of the above problem and has as a first objective to provide a broadcast program displaying apparatus which allows the same program that has been received on the broadcast program displaying apparatus to be watched continuously even in the case where a TV broadcast receiver is switched from a tuner of a broadcast program displaying apparatus (TV) to a recording and reproducing apparatus (video device) for external input.

In addition, the present invention has as a second objective to provide the broadcast program displaying apparatus which allows the same program that has been received on the recording and reproducing apparatus to be watched continuously even in the case where the TV broadcast receiver is switched from the recording and reproducing apparatus; namely a device for external input, to the tuner of the broadcast program displaying apparatus.

### Means to Solve the Problems

In order to solve the above problems, the broadcast program displaying apparatus in the present invention includes a first tuner receiving a broadcast wave, and establishes a connection to a recording and reproducing apparatus including a second tuner receiving the broadcast wave. The broadcast program displaying apparatus includes: a control unit which specifies a channel of a broadcast program currently being reproduced on the broadcast program displaying apparatus, out of broadcast programs being included in the broadcast wave received via the first tuner; an operation inputting unit which receives a first switching instruction indicating that an input path of audio and video data is to be switched from the first tuner to the recording and reproducing apparatus, the input path corresponding to the broadcast program on the broadcast program displaying apparatus; an input switching unit which switches the input path in the broadcast program displaying apparatus according to the received first switching instruction; a command inputting and outputting unit which transmits a channel selecting command to the recording and reproducing apparatus connected to the switched input path, the channel selecting command including channel information showing the channel specified by the control unit; and a data processing unit which receives audio and video data, corresponding to the channel which the channel information shows, from the recording and reproducing apparatus connected to the switched input path, and to perform data processing on the audio and video data for reproduction of the audio and video data.

This allows a user to watch continuously the same program which the broadcast program displaying apparatus has received even in the case where a receiving apparatus of the TV broadcast is switched from a tuner in the broadcast program displaying apparatus to the recording and reproducing apparatus for external input.

Further, the command inputting and outputting unit may include an infrared transmitting unit which transmits, on an infrared signal, the channel selecting command to the recording and reproducing apparatus.

Moreover, before transmitting the channel selecting command, the command inputting and outputting unit may further transmit, to the recording and reproducing apparatus, an output start instruction command for prompting the recording and reproducing apparatus to output the audio and video data.

In addition, when transmitting the output start instruction command and then receiving an output start notification command from the recording and reproducing apparatus, the command inputting and outputting unit may transmit the channel selecting command to the recording and reproducing apparatus, the output start notification command being a response to the output start instruction command.

After transmitting the channel selecting command, the command inputting and outputting unit may transmit, to the recording and reproducing apparatus, the output start instruction command for prompting the recording and reproducing apparatus to output the audio and video data.

Moreover, the broadcast program displaying apparatus may further be connected to the recording and reproducing apparatus with a wireless LAN.

In addition, the broadcast program displaying apparatus is characterized to include a data inputting unit which receives, from the recording and reproducing apparatus, the audio and video data of the broadcast program, wherein: the data processing unit further performs the data processing for reproduction on the received audio and video data; the operation inputting unit further receives a second switching instruction indicating that the input path of the audio and video data is to be switched from the recording and reproducing apparatus to the first tuner; the command inputting and outputting unit further transmits, to the recording and reproducing apparatus, a channel selection transmission instructing command requesting transmission of a channel selecting command, and to receive the channel selecting command from the recording and reproducing apparatus, the channel selecting command including the channel information showing the channel of the selected broadcast program on the recording and reproducing apparatus, the control unit further specifies the channel of the broadcast program currently being reproduced on the recording and reproducing apparatus, out of the received channel selecting command, and to change a channel on the first tuner in order to tune in to the specified channel; and the input switching unit further switches the input path from the recording and reproducing apparatus to the first tuner according to the received second switching instruction.

This allows the user to watch continuously the same program which the recording and reproducing apparatus has received even in the case where a receiving apparatus of the TV broadcast is switched from the recording and reproducing apparatus for external input to the tuner in the broadcast program displaying apparatus.

It is noted that the present invention can be implemented as: a broadcast program displaying method and a broadcast program reproducing method which include characteristic structural units in the above broadcast program displaying apparatus and the recording and reproducing apparatus as steps; and a program which causes a personal computer to execute each of the above steps in the above methods. As a matter of course, the program can be widely distributed through a recording medium such as a DVD and a distributing medium such as the Internet.

Further, the present invention can be implemented as a broadcast program display system including the above broadcast program displaying apparatus and the recording and reproducing apparatus.

### EFFECTS OF THE INVENTION

The present invention allows the same program which has been received on a broadcast program displaying apparatus to be watched continuously even in the case where a TV broadcast receiver of a broadcast program displaying apparatus (TV) is switched to a recording and reproducing apparatus (video device) for external input.

In addition, the present invention allows the same program which has been received on the recording and reproducing apparatus to be watched continuously even in the case where the TV broadcast receiver is switched from the recording and reproducing apparatus; namely an apparatus for external input, to the broadcast program displaying apparatus.

### BRIEF DESCRIPTION OF DRAWINGS

FIG. 1 is a block diagram showing an example of a functional structure of a TV and a DVD recorder of an broadcast program display system in a first embodiment.

FIG. 2 is a communication sequential diagram showing operations of the TV and the DVD recorder when selecting the DVD recorder as a device for external input in the TV of the first embodiment.

FIG. 3 is a drawing exemplifying a transition of a picture displayed on the displaying unit of the TV in the first embodiment.

FIG. 4 is a communication sequential diagram showing operations of a TV and a DVD recorder when selecting the DVD recorder as a device for external input in the TV of a second embodiment.

FIG. 5 is a communication sequential diagram showing operations of a TV and a DVD recorder when selecting the DVD recorder as a device for external input in the TV of a third embodiment.

### NUMERICAL REFERENCES

100 broadcast program display system
101 DVD recorder
102 Control unit
103 Tuner
104 Recording and reproducing unit
105 Encoder
106 Decoder
107 Operation inputting unit
108 Switch
109 Data output I/F
110 Command inputting and outputting I/F
111 DVD-RAM disc
112 Data processing unit
113 Antenna
114 Integrated circuit
121 Antenna
122 Cable for data
123 Cable for command
131 TV
132 Displaying unit
133 Speaker
134 Control unit
135 Data processing unit
136 Tuner
137 Switch
138 Operation inputting unit
139 Data input I/F
140 Command inputting and outputting I/F
141 Integrated circuit

### BEST MODE FOR CARRYING OUT THE INVENTION

Embodiments in the present invention shall be described hereinafter, referring to the drawings. It is noted that a description provided in the present invention, utilizing the following embodiments and the attached drawings, are illustrative only and not to be considered limiting. For example, the TV described below is an example of a broadcast program displaying apparatus, and the DVD recorder is an example of a recording and reproducing apparatus.

### First Embodiment

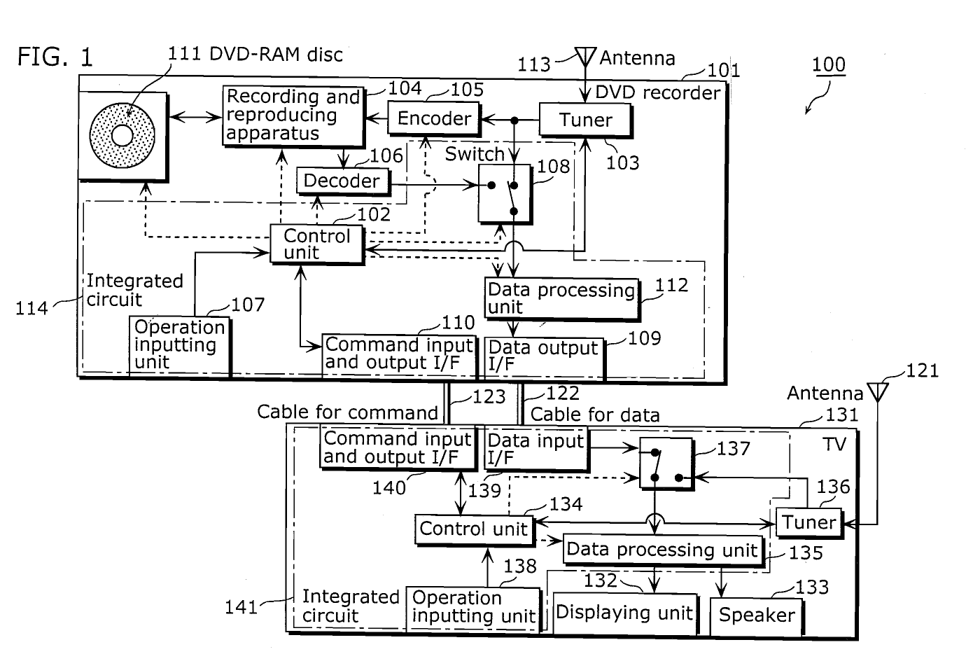

A broadcast program display system 100 in the embodiment shall be described referring to FIGS. 1 to 3. As shown in FIG. 1, the broadcast program display system 100 includes a DVD recorder 101 and a TV 131. FIG. 1 is a block diagram showing a functional structure of the TV 131 and the DVD recorder 101 in the broadcast program display system 100.

As shown in FIG. 1, the DVD recorder 101 has functions of: demodulating a broadcast wave received via an antenna 113 to extract audio and video data, and then to output the audio and video data to the TV 131; and recording the audio and video data to a DVD-RAM disc 111 and reproducing the audio and video data read out of the DVD-RAM disc 111. The DVD recorder 101 includes a control unit 102, a tuner 103, a recording and reproducing unit 104, an encoder 105, a decoder 106, an operation inputting unit 107, a switch 108, a data output interface (“data output I/F”, hereinafter) 109, a command inputting and outputting I/F 110, a data processing unit 112, and the antenna 113.

The control unit 102, a micro computer including RAM (Random Access Memory) and ROM (Read Only Memory) storing a control program, controls the entire DVD recorder 101. Further, the control unit 102 controls each of the units based on a user instruction received via the operation inputting unit 107. In addition, the control unit 102: generates a necessary command and outputs the command to the command inputting and outputting I/F 110; and analyzes a command received from the TV 131 via the command inputting and outputting I/F 110. In accordance with the analysis, the control unit 102 controls each of the units. Specifically, the control unit 102: gives instruction to the tuner 103 for setting (or changing) the channel of a broadcast program, so that the channel corresponds to channel information included in a channel selecting command received from the TV 131. The control unit 102 also specifies a channel set at the tuner 103 to generate a channel selecting command including channel information of the specified channel, and then outputs the channel selecting command to the TV 131 via the command inputting and outputting I/F 110. Further, the control unit 102 controls the switch 108 to control input paths of the audio and video data outputted to the data output I/F 109.

The tuner 103 receives a TV broadcast wave via the antenna 113 to perform demodulation and error correction on the TV broadcast wave, and outputs the audio and video data of a channel selected by the user to the encoder 105 and the switch 108. The recording and reproducing unit 104: records data encoded by the encoder 105 to the DVD-RAM disc 111; and reads the data from the DVD-RAM disc, and outputs the data to the decoder 106.

The encoder 105 performs encoding processing on the audio and video data received from the tuner 103, conforming with an MPEG specification. Further, the decoder 106 performs decoding processing on the encoded data, conforming with the MPEG specification.

The operation inputting unit 107 receives the instruction from the user via, for example, a remote or an operation button (not shown), and then notifies the control unit 102 of information showing the instruction.

The switch 108 switches the input paths of the audio and video data outputted to the data processing unit 112. Here, the audio and video data received from the tuner 103, and the audio and video data read from the recording and reproducing unit 104 and recorded to the DVD-RAM disc 111 are data in the input path to be switched. It is noted that the switch 108 perform the above switching based on an instruction from the control unit 102.

The data output I/F 109 outputs the audio and video data received from the data processing unit 112 to the TV 131 via a cable for data 122.

The command inputting and outputting I/F 110, following the instruction from the control unit 102, transmits and receives the command to and from the TV 131 (the command inputting and outputting I/F 140, to be specific) via a cable for command 123.

The data processing unit 112 outputs the audio and video data inputted via the switch 108 to the data output I/F 109. Here, responding to the instruction from the control unit 102, the data processing unit 112 also processes the audio and video data to be outputted, such as adding data for displaying a channel number which the tuner 103 receives.

Meanwhile, the TV 131, a TV receiver demodulating the broadcast wave received via a tuner to reproduce a broadcast program, includes a displaying unit 132, a speaker 133, a control unit 134, a data processing unit 135, a tuner 136, a switch 137, an operation inputting unit 138, a data inputting I/F 139, and a command inputting and outputting I/F 140. It is noted that the data output I/F 109 in the above DVD recorder 101 and the data input I/F 139 in the TV 131 are connected with the cable for data 122. Meanwhile, the command inputting and outputting I/F 110 in the D VD recorder 101 and the command inputting and outputting I/F 140 in the TV 131 are connected with the cable for command 123.

The displaying unit 132, an LCD (Liquid Crystal Display), for example, displays a picture in accordance with video data in the audio video data received from the data processing unit 135. The speaker 133 converts audio data in the audio data, received from the data processing unit 135, into audio.

The control unit 134, a microcomputer including RAM and ROM to store a control program, controls the entire TV 131. Further, the control unit 134 controls each of the units based on the user instruction received via the operation inputting unit 138. In addition, the control unit 134: generates a necessary command and outputs the command to the command inputting and outputting I/F 140; and analyzes a command received from the DVD recorder 101 via the command inputting and outputting I/F 140. In accordance with the analysis, the control unit 102 controls each of the units. Specifically, the control unit 134: gives instruction to the tuner 136 for setting (or changing) the channel of a broadcast program, so that the channel corresponds to channel information included in a channel selecting command received from the DVD recorder 101. The control unit 134 also specifies a channel set at the tuner 136 to generate a channel selecting command including channel information of the specified channel, and then outputs the channel selecting command to the DVD recorder 101 via the command inputting and outputting I/F 140. Further, the control unit 134 controls the switch 137 to control input paths of the audio and video data outputted to the data processing unit 135.

The data processing unit 135 separates the video data from the audio and video data received via the switch 137, and outputs the separated audio data to the displaying unit 132. Further, the data processing unit 135 separates the audio data from the audio and video data received via the switch 137, and outputs the separated audio data to the speaker 133.

The tuner 136 receives the TV broadcast wave via the antenna 121 to perform demodulation and error correction on the TV broadcast wave, and outputs audio and video data of a channel selected by the user to the switch 137. It is noted that the tuner 136 has an equivalent function to the function of the tuner 103 in the above DVD recorder 101.

The switch 137 selects the audio and video data to be outputted to the data processing unit 135 in accordance with an instruction of the control unit 134. Specifically, in accordance with the instruction from the control unit 134, the switch 137 selects either the audio and video data received via the data input I/F 139, or the audio and video data received via the tuner 136.

Via a remote and a switch (not shown), the operation inputting unit 138: receives a channel selection of the TV broadcast, and a switching instruction on the input paths of the audio and video data; and notifies the control unit 134 of information showing the selection and the instruction.

The data input I/F 139 receives the audio and video data from the data output I/F 109 in the DVD recorder 101 via the cable for data 122, and then outputs the audio and video data to the switch 137. Further, the command inputting and outputting I/F 140 has an equivalent function to that of the command inputting and outputting I/F 110 in the above DVD recorder 101.

Next, operations in the above structured TV 131 shall be described in the case where the DVD recorder 101 is connected to the TV 131 as one of apparatuses for external input.

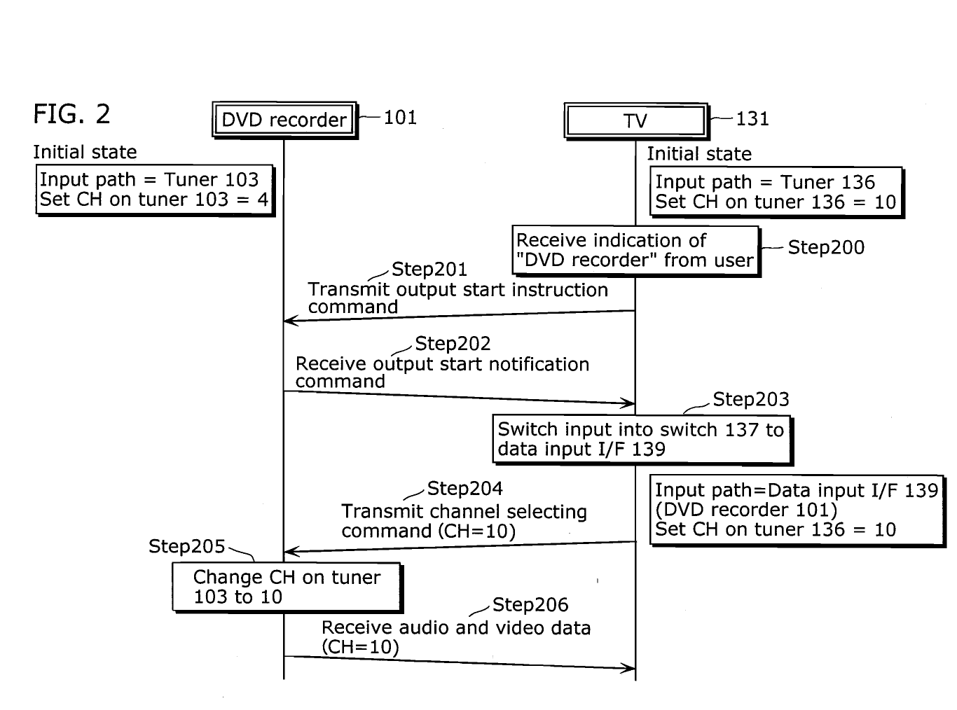

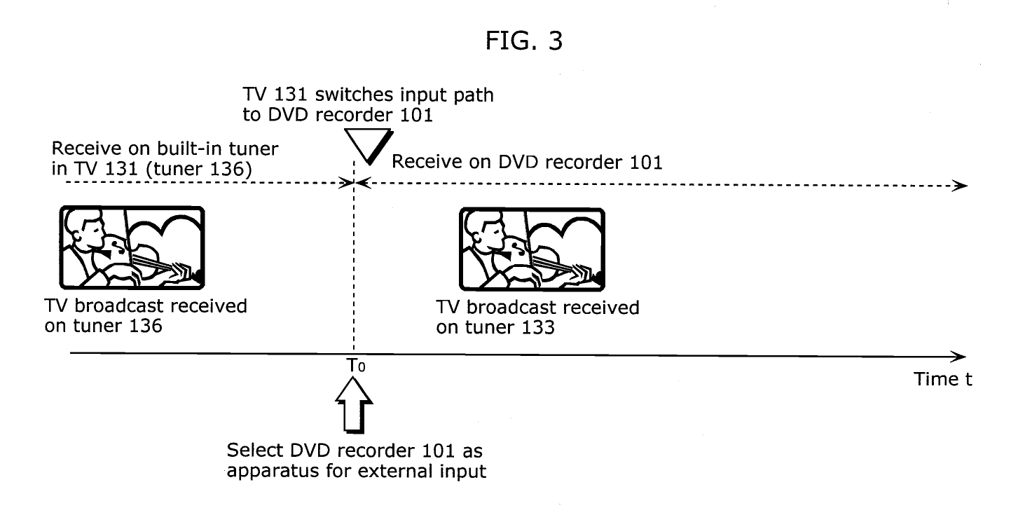

FIG. 2 is a communication sequential diagram showing the operations of the DVD recorder 101 and the TV 131 when the DVD recorder 101 is selected on the TV 131 as an apparatus for external input. In addition, FIG. 3 exemplifies a transition of a picture displayed on the displaying unit 132 of the TV 131 in the above case.

The TV 131 is an example of the broadcast program displaying apparatus in the present invention, and the DVD recorder 101 is an example of the recording and reproducing apparatus connected to the broadcast program displaying apparatus.

It is noted that operations of the DVD recorder 101 and the TV 131 shall be described, and then, the operations of the TV 131, when the DVD recorder 101 is selected as the apparatus for external input, shall be described.

(1) The Operations of the DVD Recorder 101.

The operation inputting unit 107 receives via the user operation various instructions such as “reproduction start” “reproduction stop”, and transmits information showing the instructions to the control unit 102. It is noted that the operation inputting unit 107 may include: an operation button provided on the front of the body of the DVD recorder 101; and a photo detector receiving an instruction signal, such as an infrared signal, from the remote operated by the user.

The control unit 102 controls operations on each of the units in the DVD recorder 101, in accordance with the instruction received from the operation inputting unit 107.

An operation with neither recording nor reproduction performed (as a broadcast wave receiving apparatus), a recording operation, a reproduction operation, and a command transmission and reception operation of the DVD recorder 101 shall be described hereinafter.

(a) The Operation with Neither Recording Nor Reproduction Performed (as the Broadcast Wave Receiving Apparatus).

After demodulating the TV broadcast wave received by the antenna 113, the tuner 103 takes the audio and video data of a selected channel, and then outputs the data to the encoder 105 and the switch 108.

When the DVD recorder 101 does not perform one of the recording operation and the reproduction operation, the switch 108 outputs the audio and video data received from the tuner 103 to the data processing unit 112.

The data processing unit 112 outputs the audio and video data received from the switch 108 to the data output I/F 109. Here, in response to the instruction of the control unit 102, the data processing unit 112 may process the audio and video data to be outputted, such as adding a received channel number display.

The data output I/F 109 outputs the audio and video data, received from the data processing unit 112, to the TV 131 via the cable for data 122.

The operation inputting unit 107 receives from the user a channel selection instruction specifying a channel to be received, and then outputs the channel selection instruction to the control unit 102.

Upon receiving the channel selection instruction by the user via the operation inputting unit 107, the control unit 102 notifies the tuner 103 of channel information corresponding to the channel selection instruction. This causes the tuner 103 to output to the switch 108 audio and video data of the channel specified by the notified channel information.

It is noted that a picture into which the audio and video data received by the tuner 103 is outputted with no processing performed is referred to as “EE picture” hereinafter.

(b) The Recording Operation.

Upon receiving a recording instruction by the user via the operation inputting unit 107, the control unit 102 gives the encoder 105 and the recording and reproducing unit 104 an instruction to record the audio and video data of the selected channel.

The encoder 105 converts the audio and video data received from the tuner 103 into data suitable for recording on the DVD-RAM disc 111, and then outputs the converted data to the recording and reproducing unit 104. The data suitable for recording is in the MPEG2-PS (Program Stream) format, for example.

The recording and reproducing unit 104 records the received data on the DVD-RAM disc 111.

Here, the input of the switch 108 remains to be connected to the tuner 103, and thus, the audio and video data regarding the EE picture is outputted from the data output I/F 109.

(c) The Reproduction Operation.

Upon receiving a reproduction start instruction by the user via the operation inputting unit 107, the control unit 102 gives an instruction to the decoder 106 and the recording and reproducing unit 104 to read a designated content from the DVD-RAM disc 111, and outputs the designated content to the decoder 106. Further, the control unit 102 instructs the switch 108 to switch an input path of the audio and video data to the decoder 106.

Upon receiving the above instruction from the control unit 102, the switch 108 switches the input path of the audio and video data to the decoder 106.

The recording and reproducing unit 104 reads designated content data from the DVD-RAM disc 111 and outputs the designated content data to the decoder 106.

The decoder 106 converts the received data into the audio and video data, and then outputs the converted audio and video data to the switch 108.

The switch 108 outputs to the data processing unit 112 the audio and video data received from the decoder 106.

The data processing unit 112 outputs to the data output I/F 109 the audio and video data received from the switch 108. Here, in response to the instruction of the control unit 102, the data processing unit 112 may process the audio and video data to be outputted, such as adding a character display as “reproduction”.

The data output I/F 109 outputs the audio and video data, received from the data processing unit 112, to the TV 131 via the cable for data 122.

Upon receiving a reproduction stop instruction by the user via the operation inputting unit 107, the control unit 102 gives an instruction to the decoder 106 and the recording and reproducing unit 104 to stop reproducing the content from the DVD-RAM disc 111. Moreover, the control unit 102 instructs the switch 108 to switch the input path to the tuner 103.

Upon finishing the reproduction of the DVD-RAM disc 111, the DVD recorder 101 returns to a state performing neither recording nor reproduction, and the audio and video data regarding the EE picture is outputted from the data output I/F 109.

(d) The Command Transmission and Reception Operation.

The command inputting and outputting I/F 110 transmits to the control unit 102 an output start instruction command received from the TV 131 via the cable for command 123. Upon receiving the output start instruction command, the control unit 102 instructs the command inputting and outputting I/F 110 to transmit the output start notification command. This causes the command inputting and outputting I/F 110 to transmit the output start notification command to the TV 131 via the cable for command 123.

Further, the command inputting and outputting I/F 110 transmits to the control unit 102 the channel selecting command received from the TV 131 via the cable for command 123. Based on the received channel selecting command, the control unit 102 instructs the tuner 102 to select the channel of the broadcast program.

Specifically, the control unit 102 instructs the tuner 103 to select “Channel 10” in the case where the received channel selecting command includes channel information showing “Channel 10”, for example.

(2) The Operations of the TV 131.

The operation inputting unit 138 receives various instructions such as “input switch”, “channel selection”, and “apparatus for external input selection” by the user operation. It is noted that the operation inputting unit 138 may include: an operation button provided on the body of the TV 131; and a photo detector receiving an instruction signal, such as an infrared signal, from the remote operated by the user.

Upon receiving an instruction from the user, the operation inputting unit 138 outputs to the control unit 134 instruction information showing the instruction. Based on the instruction information, the control unit 134 controls operations of each of the units in the TV 131.

A manual input switching operation, a TV broadcast watching operation, an automatic input switching operation and a command transmitting and receiving operation, in the TV 131, shall be described hereinafter.

(a) The Manual Input Switching Operation Mode.

Upon receiving an input switching instruction by the user via the operation inputting unit 138, the control unit 134 sends to switch 137 an instruction for switching the input paths. For example, when the switch 137 receives from the control unit 134 an instruction to switch the input path to the data input I/F 139 in the case where the tuner 136 outputs the audio and video data to the data processing unit 135 via the switch 137, the switch 137 switches the input paths so that the audio and video data received from the data input I/F 139 is outputted to the data processing unit 135.

(b) The TV Broadcast Watching Operation Mode.

In the TV broadcast watching operation mode, an input path in the switch 137 is set to the tuner 136.

Upon demodulating the TV broadcast wave received via the antenna 121, the tuner 136 takes the audio and video data of a selected channel, and then outputs the audio and video data to the switch 137. The switch 137 receives the audio and video data from the tuner 136, and outputs the audio and video data to the data processing unit 135.

Out of the audio and video data received from the switch 137, the data processing unit 135 outputs: video data to the displaying unit 132; and audio data to the speaker 133. Here, based on an instruction from control unit 134, the data processing unit 135 may process (add video data, to the video data, for displaying the channel number of a channel on reception) the video data to be outputted.

(c) The Automatic Input Switching Operation.

Upon receiving a command from the DVD recorder 101 via the cable for command 123, the command inputting and outputting I/F 140 outputs the command to the control unit 134.

In the case where the command received from the command inputting and outputting I/F 140 is the output start notification command, the control unit 134 sends an instruction to switch 137 to switch the input path to the data input I/F 139. This causes the switch 137 to switch the input path of the audio and video data to the data input I/F 139.

(d) The Command Transmitting and Receiving Operation.

As needed, the control unit 134 transmits a command transmission instruction to the command inputting and outputting I/F 140.

Upon receiving the command transmission instruction from the control unit 134 the command inputting and outputting I/F 140 transmits a designated command to the DVD recorder 101 via the cable for command 123. As the command to be transmitted, for example, the channel selecting command is intended, which gives an instruction to a target apparatus (the DVD recorder 101, in this case) in order to select a designated channel.

The operations in the case where the DVD recorder 101 is selected, on the TV 131, as one of apparatuses for external input

Next, FIGS. 2 and 3 describe: operations of the DVD recorder 101 and the TV 131 in the case where the DVD recorder 101 is selected, on the TV 131 as an apparatus for external input; and how transition of the displayed pictures occurs on the TV 131.

First, it is assumed that the input path of the audio and video data in the TV 131 is set to the tuner 136, and TV broadcast received by the tuner 136 is presented to the user. Here, the tuner 136 is assumed to select “Channel 10” as a channel of a broadcast program to be received.

In addition, the DVD recorder 101 is assumed to perform neither reproduction nor recording, and the input path in the switch 108 is assumed to be set to tuner 103. Further, on the tuner 103, “Channel 4” is assumed to be set as a channel of a broadcast program.

First, when the DVD recorder 101 is selected as an apparatus for external input by the user instruction on the TV 131 (Step 200), the TV 131 transmits to the DVD recorder 101 the output start instruction command (Step 201).

Next, upon receiving output start instruction command, the DVD recorder 101 transmits the output start notification command to the TV 131 (Step 202).

Upon receiving the output start notification command from the DVD recorder 101, the TV 131 switches the input path in the switch 137 to the data input I/F 139 (Step 203).

Further, the TV 131 transmits the channel selecting command to the DVD recorder 101 (Step 204). Here, the channel selecting command includes channel information showing a selected channel on the tuner 136 (“Channel 10” in the example of FIG. 2).

Then, upon receiving the channel selecting command from the TV 131, the DVD recorder 101 sets the channel selection of the broadcast program on the tuner 103 to “Channel 10” (Step 205), and then transmits to the TV 131 the audio and video data of the broadcast program “Channel 10” (Step 206).

In the above operations, pictures displayed on the TV 131 are illustrated as shown in FIG. 3. In other words, in the initial state, the user watches the program received on the tuner 136 built in the TV 131 (Channel 10). When the user selects the DVD recorder 101 as an apparatus for external input: the input path of the audio and video data in the TV 131 is switched to the DVD recorder 101 (Step 203); and, at the same time, the channel of the broadcast program received on the tuner 103 in the DVD recorder 101 is switched to the same program on the TV 131 “Channel 10” (Step 205).

As mentioned above, the broadcast program displaying apparatus in the embodiment enables the user to watch continuously a program watched on the broadcast program displaying apparatus (the TV 131) even though an input path of audio and video data is switched from a built-in tuner in the broadcast program displaying apparatus to a recording and reproducing apparatus for external input (DVD recorder 101).

It is noted that in the communication sequential diagram shown in the above FIG. 2, the channel numbers selected on the tuner 103 and the tuner 136 are one example.

Further, in the above DVD recorder 101, actual timing to start outputting the audio and video data from the data output I/F 109 may be: the same as timing to transmit the output start notification command; or timing that an input target of the audio and video data in the TV 131 is switched to the DVD recorder 101 (in other words, the input path in the switch 137 is switched to the data input I/F 139). Further, the audio and video data may be firmly outputted from the data output I/F 109.

### Second Embodiment

The above first embodiment has exemplified that, from the TV 131 to the DVD recorder 101, the “output start instruction command” is transmitted, and then the “channel selecting command” is transmitted. Meanwhile, the second embodiment exemplifies that the “channel selecting command” is transmitted first, and then an “output start instruction command” is transmitted. It is noted that a functional structure of the TV 131 and the DVD recorder 101 in the second embodiment is basically equivalent to the functional structure in the above first embodiment.

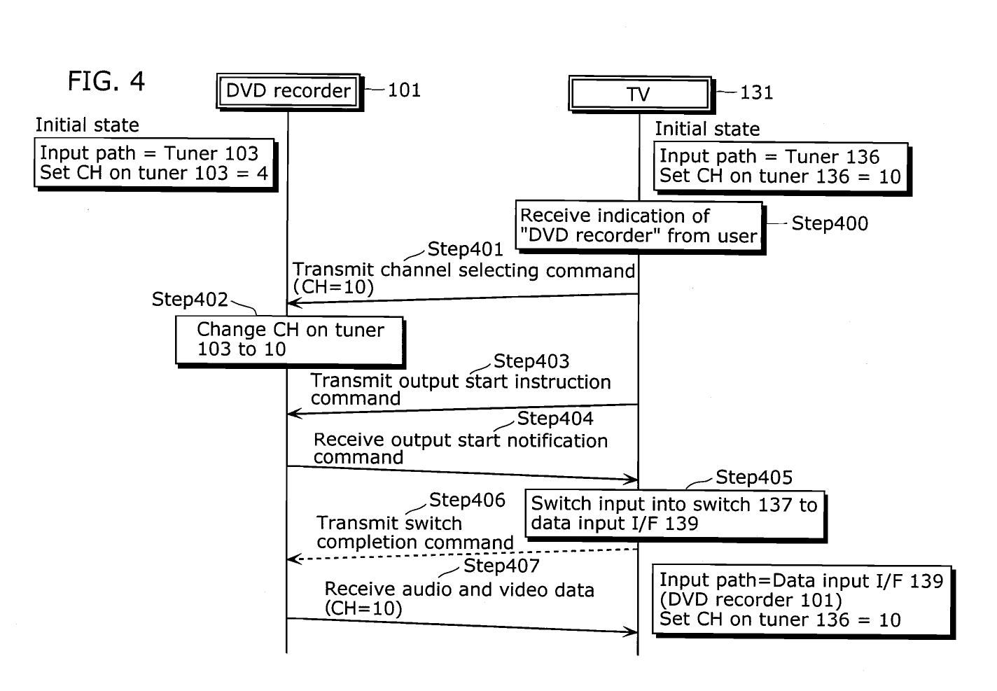

FIG. 4 is a communication sequential diagram in the embodiment, showing operations of the TV 131 and the DVD recorder 101 when the DVD recorder 101 is selected on the TV 131 as an apparatus for external input.

First, it is assumed that the input path of the audio and video data in the TV 131 is set to the tuner 136, and the user is watching TV broadcast received by the tuner 136. Here, the tuner 136 is assumed to select “Channel 10” as a channel.

In addition, the DVD recorder 101 is assumed to perform neither reproduction nor recording, and the switch 108 is assumed to be connected to the tuner 103. The tuner 103 is assumed to select “Channel 4” as a channel.

First, when a “DVD recorder” is selected as an apparatus for external input by the user on the TV 131 (Step 400), the TV 131 transmits to the DVD recorder 101 the channel selecting command (Step 401). Here, the channel selecting command includes, as a parameter, channel information of the channel selected on the tuner 136 (“Channel 10 in the example of FIG. 4).

Next, upon receiving the channel selecting command, the DVD recorder 101 changes the channel on the tuner 103 in accordance with the channel information included in the channel selecting command (Channel 10).

Further, in a section of time elapsed after the above channel selecting command has transmitted (0.1 seconds, for example), the TV 131 transmits to the DVD recorder 101 the “output start instruction command” (Step 403). Upon receiving the output start instruction command, the DVD recorder 101 returns the output start notification command to the TV 131 (Step 404).

Upon receiving the output start notification command, the TV 131 switches the input path in the switch 137 to the data input I/F 139 (Step 405), and then transmits to the DVD recorder 101 a “switch completion command” showing that the switching of the input path has been completed (Step 406).

Then, the DVD recorder 101 transmits the audio and video data to the TV 131 (Step 407). It is noted that the transmission of the switch completion command from the TV 131 to the DVD recorder 101 described above (Step 406) may be omitted. In the above operations, pictures displayed on the TV 131 are illustrated as the drawings shown in FIG. 3 in the above first embodiment. In other words, in the initial state, the TV 131 displays a program received by the built-in tuner 136 (Channel 10). When the user selects the DVD recorder 101 as an apparatus for external input: the channel on the tuner 103 in the DVD recorder 101 is switched to the same program on the TV 131 “Channel 10” (Step 402 in FIG. 4); and, at the same time, the input path of the audio and video data in the TV 131 is switched to the DVD recorder 101 (Step 405 in FIG. 4).

As described above, the user can continue watching a program which the user has watched on the TV 131 even in the case where the user switches apparatuses, including a tuner, for external input.

It is noted that in the communication sequential diagram shown in the above FIG. 4, the programs selected on the tuner 103 and the tuner 136 may be other programs.

Further, in the above DVD recorder 101, actual timing to start outputting the audio and video data from the data output I/F 109 may be: the same as timing to transmit the output start notification command; in a section of time elapsed after the output start notification command has transmitted; or timing that an input target of the audio and video data in the TV 131 is switched to the DVD recorder 101 (in other words, the input path in the switch 137 is switched to the data input I/F 139). Further, the audio and video data may be firmly outputted from the data output I/F 109.

### Third Embodiment

The above first and second embodiments have described that the same program can be watched even in the case where the input path is switched from the tuner 136 to the DVD recorder 101 in the TV 131. The third embodiment, on the contrary, shall be described in that even in the case where the input path is switched from the DVD recorder 101 to the built-in tuner 136 in the TV 131, the user can continue watching the same program. It is noted that each of the units in the TV 131 and the DVD recorder 101 of the third embodiment further includes the following functions, in addition to each of the functions in the first embodiment described above.

Upon receiving an instruction, via the operation inputting unit 138, for switching from the DVD recorder 101 to the TV 131 (in other words, for switching the input path from the data input I/F 139 to the tuner 136), the control unit 134 instructs the switch 137 to switch the input path to the tuner 136. Here, the control unit 134: transmits a “channel selection transmission instructing command” to the DVD recorder 101 via the command inputting and outputting I/F 140; and receives from the DVD recorder 101 the “channel selecting command” via the command inputting and outputting I/F 140. The channel selecting command includes channel information showing a channel selected on the tuner 103 in the DVD recorder 101. Further, the control unit 134 instructs the tuner 136 to change the channel selection in accordance with the channel information included in the channel selecting command received from the DVD recorder 101.

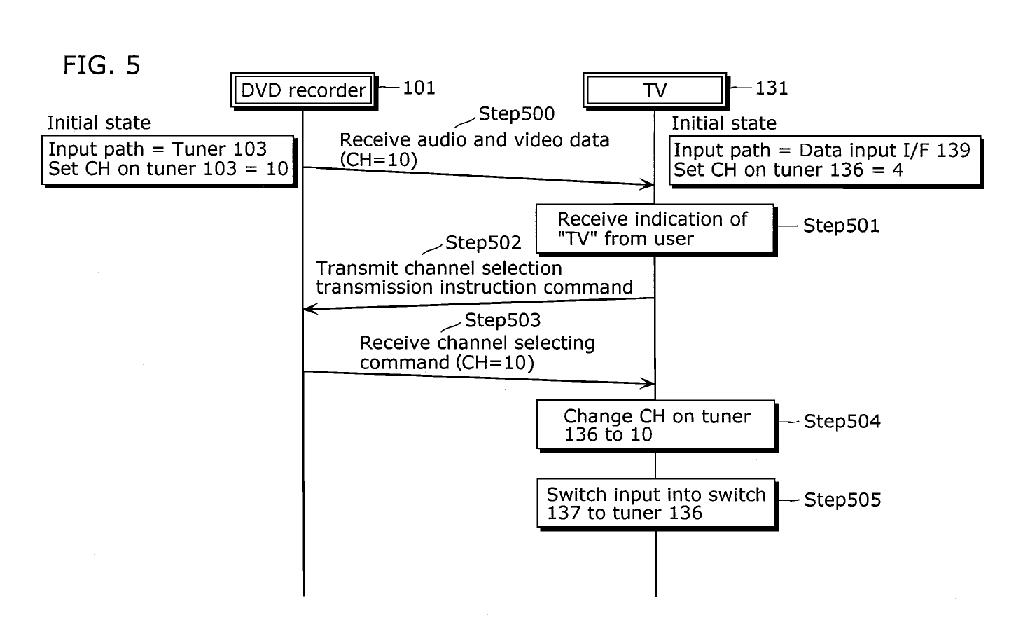

FIG. 5 is a communication sequential diagram showing operations of the TV 131 and the DVD recorder 101 when the input path is switched from the DVD recorder 101 for external input to the built-in tuner 136 in the TV 131 of the embodiment.

First, as the initial state, it is assumed that the input path of the audio and video data in the TV 131 is set to the DVD recorder 101, and, on the TV 131, the user is watching TV broadcast received by the tuner 103 in the DVD recorder 101 (Step 500). Here, the tuner 103 is assumed to select “Channel 10” as a channel.

It is also assumed that the switch 137 in the TV 131 is connected to the data input I/F 139, and the tuner 136 selects “Channel 4” as a channel.

First, when “TV” is selected as the input path on the TV 131 by the user (Step 501), the control unit 134 transmits the “channel selection transmission instructing command” to the DVD recorder 101 (Step 502).

This causes the control unit 102 in the DVD recorder 101 to generate a channel selecting command including channel information showing “CH=10” set on the tuner 103, and to transmit the generated channel selecting command to the TV 131 (in other words, the command inputting and outputting I/F 110) (Step 503).

Upon receiving the channel selecting command from the DVD recorder 101, the TV 131 changes a channel selection of the tuner 136 to “Channel 10”, in accordance with the channel information included in the received channel selecting command (Step 504), and switches the input path in the switch 137 to the tuner 136 (Step 505).

In the above operation, the user can continue watching a program watched on the DVD recorder 101, even though the input path in the TV 131 is switched from “DVD recorder” to “TV” (in other words, the built-in tuner 136).

It is noted that, in the communication sequential diagram shown in the above FIG. 5, the programs selected on the tuner 103 and the tuner 136 may be other programs than those in the above embodiment.

In addition, the DVD recorder 101 in the above first to third embodiments may: have an external input I/F for connecting to an apparatus for external input; and switch between audio and video data inputted from the apparatus for external input and TV broadcast received by the tuner 103.

Further, instead of the DVD-RAM disc, a recording medium for recording and reproducing on the DVD recorder 101 in the above first to third embodiments may be: another removable medium such as a DVD-R disc; a stationary medium such as a hard disc; or a recording and reproducing apparatus which can record and reproduce one kind or several kinds of recording media. Moreover, a play-only apparatus without an encoder; namely a DVD player only reproducing a recording medium such as a DVD-RAM, may be used instead of a DVD recorder.

In addition, the recording and reproducing apparatus in the present invention may be a DVD player and a set top box without a recording function, instead of the DVD recorder 101 having a recording function.

Further, the TV 131 is intended for having one data input I/F. Instead, the TV 131 may have two or more data input I/Fs. Those data input I/Fs may be in an identical kind or in different kinds. Moreover, the number of apparatuses to be connected to the data input I/F at once may be one, or two or more. In other words, the recording and reproducing apparatus in the present invention may be configured to specify a source apparatus of a command received at the command inputting and outputting I/F 140, and to switch the input path in the TV 131 to the source apparatus of the command.

In addition, the cable for data 122 and the cable for command 123 may be in one cable, two or more cables, or one cable with several signal lines bundled together. Further, instead of a cable, a wireless signal such as infrared may be utilized for transmission.

It is noted that, as shown in FIG. 1, the present invention can be implemented as: an integrated circuit 141 (an area surrounded with an alternate long and short sash line) including a characteristic structural element in the above broadcast program displaying apparatus; and an integrated circuit 114 (an area surrounded with an alternate long and short sash line) including a characteristic structural element in the above recording and reproducing apparatus.

### INDUSTRIAL APPLICABILITY

The present invention can provide an broadcast program displaying apparatus which allows a user to automatically watch the same program on a recording and reproducing apparatus as the user has watched on the broadcast program displaying apparatus, when switching, to recording and reproducing apparatus, an input target of audio and video data on the broadcast program displaying apparatus (TV).

1-13. (canceled)

14. A broadcast program displaying apparatus which includes a first tuner receiving a broadcast wave, and which establishes a connection to a recording and reproducing apparatus including a second tuner receiving the broadcast wave, said broadcast program displaying apparatus comprising:
a control unit configured to specify a channel of a broadcast program currently being reproduced on said broadcast program displaying apparatus, out of broadcast programs being included in the broadcast wave received via the first tuner;
an operation inputting unit configured to receive a first switching instruction indicating that an input path of audio and video data is to be switched from the first tuner to the recording and reproducing apparatus, the input path corresponding to the broadcast program on said broadcast program displaying apparatus;
an input switching unit configured to switch the input path in said broadcast program displaying apparatus according to the received first switching instruction;
a command inputting and outputting unit configured to transmit a channel selecting command to the recording and reproducing apparatus connected to the switched input path, the channel selecting command including channel information showing the channel specified by said control unit; and
a data processing unit configured to receive audio and video data, corresponding to the channel which the channel information shows, from the recording and reproducing apparatus connected to the switched input path, and to perform data processing on the audio and video data for reproduction of the audio and video data,
wherein, before transmitting the channel selecting command, said command inputting and outputting unit is further configured to have transmitted, to the recording and reproducing apparatus, an output start instruction command for prompting the recording and reproducing apparatus to output the audio and video data, and when transmitting the output start instruction command and then receiving an output start notification command from the recording and reproducing apparatus, said command inputting and outputting unit is configured to transmit the first switching instruction to said input switching unit, the output start notification command being a response to the output start instruction command.

15. The broadcast program displaying apparatus according to claim 14,
wherein said command inputting and outputting unit includes an infrared transmitting unit configured to transmit, on an infrared signal, the channel selecting command to the recording and reproducing apparatus.

16. The broadcast program displaying apparatus according to claim 14, which is further connected to a switching interface apparatus,
wherein said switching interface apparatus can establish a connection to one or more other recording and reproducing apparatuses than the recording and reproducing apparatus,
said control unit in said broadcast program displaying apparatus further receives a second output start notification command indicating that the input path in said broadcast program displaying apparatus is to be switched from the first tuner to said switching interface apparatus,
said input switching unit in said broadcast program displaying apparatus further switches the input path in the broadcast program displaying apparatus to said switching interface apparatus according to the output start notification command, and
said switching interface apparatus includes:
a second command inputting and outputting unit configured to receive the second output start notification command;
a second input switching unit configured to switch the input path in said broadcast program displaying apparatus from the first tuner to the other one of recording and reproducing apparatuses in the case where said broadcast program displaying apparatus receives the second output start notification command from the other one of recording and reproducing apparatuses; and
a data inputting unit configured to transmit audio and video data outputted from the other one of recording and reproducing apparatuses to said input switching unit in said broadcast program displaying apparatus.

17. The broadcast program displaying apparatus according to claim 14,
wherein said broadcast program displaying apparatus is further connected to the recording and reproducing apparatus with a wireless LAN.

18. The broadcast program displaying apparatus according to claim 14, further comprising
a data inputting unit configured to receive, from the recording and reproducing apparatus, the audio and video data of the broadcast program,
wherein the data processing unit is further configured to perform the data processing for reproduction on the received audio and video data,
said operation inputting unit is further configured to receive a second switching instruction indicating that the input path of the audio and video data is to be switched from the recording and reproducing apparatus to the first tuner,
said command inputting and outputting unit is further configured to transmit, to the recording and reproducing apparatus, a channel selection transmission instructing command requesting transmission of a channel selecting command, and to receive the channel selecting command from the recording and reproducing apparatus, the channel selecting command including the channel information showing the channel of the selected broadcast program on the recording and reproducing apparatus,
said control unit is further configured to specify the channel of the broadcast program currently being reproduced on the recording and reproducing apparatus, out of the received channel selecting command, and to change a channel on the first tuner in order to tune in to the specified channel, and
said input switching unit is further configured to switch the input path from the recording and reproducing apparatus to the first tuner according to the received second switching instruction.

19. A broadcast program displaying system comprising: a broadcast program displaying apparatus including a first tuner receiving a broadcast wave; and a recording and reproducing apparatus including a second tuner receiving the broadcast wave,
wherein the recording and reproducing apparatus is connected to said broadcast program displaying apparatus, and
said broadcast program displaying apparatus includes:
an operation inputting unit configured to receive a switching instruction indicating that a reception path of a broadcast program on said broadcast program displaying apparatus is to be switched from the first tuner to the recording and reproducing apparatus, or from the recording and reproducing apparatus to the first tuner;
a control unit configured, based on the switching instruction, to specify a channel of a broadcast program currently being reproduced on said broadcast program displaying apparatus, out of broadcast programs included in the broadcast wave received via the first tuner, or to request the recording and reproducing apparatus to transmit a channel selecting command including channel information showing a channel of a selected broadcast program on the recording and reproducing apparatus;
a command inputting and outputting unit configured to transmit the channel selecting command to the recording and reproducing apparatus connected to a switched input path, or to receive the channel selecting command from the recording and reproducing apparatus before the switching of the input path, the channel selecting command including channel information showing the channel specified by said control unit;
an input switching unit configured to switch the input path in said broadcast program displaying apparatus according to the received switching instruction; and
a data processing unit configured to receive audio and video data from the recording and reproducing apparatus to which the switched input path is connected, or to receive audio and video data, from the first tuner, of the specified channel, and configured to perform data processing for reproduction.

20. The broadcast program displaying system according to claim 19,
wherein the recording and reproducing apparatus in said broadcast program displaying system includes:
a command inputting and outputting unit configured to (1) transmit the channel selecting command to said broadcast program displaying apparatus in the case where the recording and reproducing apparatus receives, from said broadcast program displaying apparatus, the channel selection transmission instructing command requesting transmission of the channel selecting command including the channel information showing the channel of the selected broadcast program on the recording and reproducing apparatus, or (2) receive the channel selecting command from said broadcast program displaying apparatus; and
a control unit configured to (1) specify the channel of the broadcast program out of broadcast programs included in a broadcast wave received via the second tuner, and to transmit to said broadcast program displaying apparatus a channel selection command including information of the specified channel in the case where the recording and reproducing apparatus receives the channel selection transmission instructing command from said broadcast program displaying apparatus, or (2) specify a channel of a broadcast program out of the channel selecting command, and to change a channel of the second tuner in the case where the recording and reproducing apparatus receives the channel selecting command from said broadcast program displaying apparatus.

21. A broadcast program displaying method in a broadcast program display system which includes: a broadcast program displaying apparatus having a first tuner receiving a broadcast wave; and a recording and reproducing apparatus having a second tuner receiving the broadcast wave, the broadcast program displaying apparatus establishing a connection to the recording and reproducing apparatus, and said broadcast program displaying method comprising:
controlling for specifying a channel of a broadcast program currently being reproduced on the broadcast program displaying apparatus, out of broadcast programs included in the broadcast wave received via the first and second tuners, said controlling being performed by a control unit;
operation inputting for receiving a first switching instruction indicating that a reception path of the broadcast program in the broadcast program displaying apparatus is to be switched from the first tuner to the recording and reproducing apparatus, or from the recording and reproducing apparatus to the first tuner, said operation inputting being performed by an operation inputting unit;
input switching an input path in the broadcast program displaying apparatus according to the received first switching instruction, said input switching being performed by an input switching unit;
command inputting and outputting for transmitting channel information showing the specified channel in said controlling to either the recording and reproducing apparatus or the first tuner is connected to the switched input path, said command inputting and outputting being performed by a command inputting and outputting unit; and
data processing for receiving audio and video data, corresponding to the channel which the channel information shows, from either the recording and reproducing apparatus or the first tuner is connected to the switched input path, and for performing data processing on the audio and video data for reproduction, said data processing being performed by a data processing unit,
wherein, before transmitting the channel selecting command, in said command inputting and outputting, an output start instruction command, for prompting the recording and reproducing apparatus to output the audio and video data, is transmitted to the recording and reproducing apparatus, and when transmitting the output start instruction command and then receiving an output start notification command from the recording and reproducing apparatus, in said command inputting and outputting, the first switching instruction is transmitted to the input switching unit, the output start notification command being a response to the output start instruction command.

22. A program for use with a broadcast program displaying apparatus which includes a first tuner receiving a broadcast wave, the broadcast program displaying apparatus establishing a connection to a recording and reproducing apparatus including a second tuner which receives the broadcast wave, and said program causing a computer to execute:
controlling for specifying a channel of a broadcast program currently being reproduced on the broadcast program displaying apparatus, out of broadcast programs included in the broadcast wave received via the first tuner, said controlling being performed by a control unit;
operation inputting for receiving a first switching instruction indicating that an input path of audio and video data is to be switched from the first tuner to the recording and reproducing apparatus, the input path corresponding to the broadcast program on the broadcast program displaying apparatus, said operation inputting being performed by an operation inputting unit;
input switching the input path in the broadcast program displaying apparatus according to the received first switching instruction, said input switching being performed by an input switching unit;
command inputting and outputting for transmitting a channel selecting command to the recording and reproducing apparatus connected to the switched input path, the channel selecting command including channel information showing the channel specified in the controlling, said command inputting and outputting being performed by a command inputting and outputting unit; and
data processing for receiving the audio and video data, corresponding to the channel which the channel information shows, from the recording and reproducing apparatus connected to the switched input path, and for performing data processing for reproduction on the audio and video data, said data processing being performed by a data processing unit,
wherein, before transmitting the channel selecting command, in said command inputting and outputting, an output start instruction command, for prompting the recording and reproducing apparatus to output the audio and video data, is transmitted to the recording and reproducing apparatus, and when transmitting the output start instruction command and then receiving an output start notification command from the recording and reproducing apparatus, in said command inputting and outputting, the first switching instruction is transmitted to the input switching unit, the output start notification command being a response to the output start instruction command.

23. An integrated circuit for use with a broadcast program displaying apparatus which includes a first tuner receiving a broadcast wave, the broadcast program displaying apparatus establishing a connection to a recording and reproducing apparatus including a second tuner receiving the broadcast wave, and said integrated circuit comprising:
a control unit configured to specify a channel of a broadcast program currently being reproduced on the broadcast program displaying apparatus, out of broadcast programs included in the broadcast wave received via the first tuner;
an operation inputting unit configured to receive a first switching instruction indicating that an input path of audio and video data is to be switched from the first tuner to the recording and reproducing apparatus, the input path corresponding to the broadcast program on the broadcast program displaying apparatus;
an input switching unit configured to switch the input path in the broadcast program displaying apparatus according to the received first switch instruction;
a command inputting and outputting unit configured to transmit a channel selecting command to the recording and reproducing apparatus connected to the switched input path, the channel selecting command including channel information showing the channel specified by said control unit; and
a data processing unit configured to receive the audio and video data, corresponding to the channel which the channel information shows, from the recording and reproducing apparatus connected to the switched input path, and to perform data processing for reproduction on the audio and video data,
wherein, before transmitting the channel selecting command, said command inputting and outputting unit is further configured to have transmitted, to the recording and reproducing apparatus, an output start instruction command for prompting the recording and reproducing apparatus to output the audio and video data, and when transmitting the output start instruction command and then receiving an output start notification command from the recording and reproducing apparatus, said command inputting and outputting unit is configured to transmit the first switching instruction to said input switching unit, the output start notification command being a response to the output start instruction command.

24. An integrated circuit for use with a recording and reproducing apparatus which includes a second tuner receiving a broadcast wave, the recording and reproducing apparatus establishing a connection to a broadcast program displaying apparatus including a first tuner which receives the broadcast wave, and said integrated circuit comprising:
a command inputting and outputting unit configured to (1) transmit a channel selecting command to the broadcast program displaying apparatus in the case where said command inputting and outputting unit receives, from the broadcast program displaying apparatus, a channel selection transmission instructing command requesting transmission of the channel selecting command including channel information showing a channel of a selected broadcast program on the recording and reproducing apparatus, or (2) receive the channel selecting command from the broadcast program displaying apparatus; and
a control unit configured to (1) specify the channel of the broadcast program out of broadcast programs included in the broadcast wave received via the second tuner, and to transmit to the broadcast program displaying apparatus a channel selection command including information of the specified channel in the case where the recording and reproducing apparatus receives the channel selection transmission instructing command from the broadcast program displaying apparatus, the broadcast programs being, or (2) specify a channel of a broadcast program out of the channel selecting command, and to change a channel of the second tuner in the case where the recording and reproducing apparatus receives the channel selecting command from the broadcast program displaying apparatus.
